(19) United States
(12) Patent Application Publication
(10) Pub. No.: US 2020/0202852 A1
(43) Pub. Date: Jun. 25, 2020

(54) INFRARED EMITTING DEVICE AND CONTROL SYSTEM FOR ELECTRONIC DEVICE

(71) Applicant: SHENZHEN LENKENG TECHNOLOGY CO., LTD., Shenzhen City (CN)

(72) Inventor: BINGHAI GAO, Shenzhen City (CN)

(21) Appl. No.: 16/443,867

(22) Filed: Jun. 17, 2019

(30) Foreign Application Priority Data
Dec. 20, 2018 (CN) 201822148625.9

(51) Int. Cl. G10L 15/22; G10L 15/08; G10L 21/0208; G10L 25/84

(52) U.S. Cl. CPC G10L 15/22; G10L 15/08; G10L 2015/223; G10L 25/84; G10L 21/0208

(57) ABSTRACT

An infrared emitting device for converting a voice command into an infrared signal and transmitting it to an electronic device to control the electronic device, including a storage module, a first collecting module, and a preprocessing a module, a voice recognition module, and an infrared transmitter. The storage module is configured to store a preset voice feature; the first collecting module is configured to collect voice data; the preprocessing module is configured to obtain a target voice; the voice recognition module is configured to extract target voice features from the target voice, and compare the obtained target voice feature with a preset voice feature. When a ratio of the target voice feature to the preset voice feature is greater than or equal to a set threshold the infrared emission generates an infrared signal and transmits the infrared signal to an electronic device to control the electronic device.

### TECHNICAL FIELD

The present invention relates to the technical field of infrared control technology, in particular to an infrared emitting device and a control system for electronic device.

### BACKGROUND

With the rise intelligent life and smart homes, using voice commands to control smart home appliances has become an emerging technology. Typically, in a voice command control system for electronic device, voice recognition and conversion are key functions of the voice command control system. When the voice recognition and conversion function are performed, first, a voice command from a user is collected, second, the features of the collected voice commands are extracted, and third, the extracted voice features are recognized. Such that the content of the voice commands and identification of the user are recognized.

Since voice collection and voice conversion are the key functions of voice command control system, how to improve the accuracy of voice collection and conversion in a remote control device and transmit the voice cotrol device to ensure to correctly control the electronic device is desired to solve in those skilled in the art.

### SUMMARY

In order to overcome the deficiencies of the prior art, it is an object of the present invention to provide an infrared emitting device and a control system for electronic device.

In one aspect, the present invention provides an infrared emitting device configured to convert a voice command into an infrared signal and transmitting the infrared signal to an electronic device for controlling the electronic device. The infrared emitting device comprises a first collecting module configured to collect user's voice data; an voice recognition module configured to extract target voice features from the target voice and compare the target voice feature with a preset voice feature; an infrared emitter configured to emit a corresponding infrared signal to the electronic device for controlling the electronic device when the target voice feature match the preset voice feature.

The infrared emitting device further comprises a transmitting module, the infrared emitting device comprising a first body, and a second body detachably coupled to the first body, the first collecting module is located in the first body, the voice recognition module and the infrared emitter are located in the second body, the first collecting module is communicated with the voice recognition module via the transmitting element.

The transmitting module comprises a transmitting line, the transmitting line is crimped in the first body or the second body, when the first body is detached from the second body, the transmitting line is expanded.

The transmitting module comprises a first communicating unit, and a second communicating unit wirelessly communicated with the first communicating unit; the first communicating unit is located in the first body, second communicating unit is located in the second body, the first interface and the second interface are wirelessly communicated detachably couple together. A radio frequency used by the first interface and the second interface is 2.4G, 5.8 GHz, 433 MHz, or in a range of 902-928 MHz.

The infrared emitting device further comprises a preprocessing module, configured to receive the voice data and pre-process the voice data to obtain a target voice.

The infrared emitting device further comprises a storage module, configured to store a preset voice command having a preset voice feature.

The infrared emitting device comprising a body, and the first collecting module, voice recognition module and the infrared emitter are located in the body.

The infrared emitting device further comprises a preprocessing module, configured to receive the voice data and preprocess the voice data to obtain a target voice.

The infrared emitting device further comprises a storage module, configured to store a preset voice command having a preset voice feature.

The preprocessing module comprises an interference suppression unit and a noise filtering unit, wherein the interference suppression unit is connected to the first collecting module, and the voice data is processed by the interference suppression unit to obtain a high SNR voice data; the noise filtering unit is connected to the interference suppression unit for processing the high SNR voice data to obtain the target voice.

An infrared storage unit is disposed in the infrared emitter, the infrared storage unit stores an infrared code, and the infrared code is associated with the preset voice command; When the ratio of the target voice feature to the preset voice feature is greater than or equal to a set threshold, the infrared emitter transmits an infrared signal generated by the infrared code associated with the preset voice feature to the electronic device.

The array is distributed in a circular array, a rectangular array or a polygonal array.

The infrared emitting device further comprises a second collecting module, wherein the second collecting module is connected to the preprocessing module for acquiring an environment noise, the ambient noise level is analyzed, and the ambient noise level information is feed back to the preprocessing module.

The second collecting module comprises a level preset unit, a noise collection unit, and a noise analysis unit; the level preset unit is configured to preset a noise level, the noise collecting unit is configured to collect ambient noise; the noise analyzing unit is connected to the level preset unit and the noise collecting unit, and is used for comparing the ambient noise collected by the noise collecting unit with the preset noise level of the level preset unit, and determining the noise level collected by the noise collection unit, and transmitting the feedback signal of the noise level to the preprocessing module.

In another aspect, the present invention provides an electrical control system comprising an electronic device and an infrared emitting device. The infrared emitting device comprises a first collecting module configured to collect user's voice data of the user; an voice recognition module connected to a preprocessing module and configured to perform extract target voice features from the target voice, and compare the obtained target voice feature with a preset voice feature; an infrared emitter configured to emit a corresponding infrared signal to the electronic device for controlling the electronic device, when the target voice feature match the preset voice feature.

Compared with the prior art, an infrared emitting device provided by the present invention has the following advantages:

By using the storage module to store the user preset voice command locally, the voice command data can be quickly called without using the cloud to store the voice command. At the same time, the first collecting module is used to acquire the user's voice data, and the interference suppression unit of the preprocessing module first suppresses the interference signal of the voice data, improves the signal-to-noise ratio of the voice data, and then uses the noise filtering unit to further eliminate the interference signal, effectively retain the user's voice in the voice data, that is, the target voice; then extract the voice feature in the target voice through the voice recognition module, and compare the feature of the acquired target voice feature with the preset voice command, if the contrast ratio is greater than or equal to the set threshold, a feedback signal is sent to the infrared emitter, and the infrared signal is sent to the electronic device to control the electronic device.

By setting the self-set voice collection module and the voice binding module, the user can effectively expand the extension of the preset voice command, so that multiple voice commands can be used to control the same action of the electronic device, thereby effectively reducing the situation that users cannot operate electrical equipment because of forgetting voice commands.

Setting the second collecting module, the second collecting module be used to obtain the environmental noise and analyze the noise level of the environmental noise, and feedback the noise level to the preprocessing module, so that the preprocessing module adjusts the noise filtration intensity according to different noise levels to obtain better target voice, ensuring better sound recognition.

### BRIEF DESCRIPTION OF THE DRAWINGS

FIG. 1 is a structural block diagram of an infrared emitting device according to a first embodiment of the present invention.

FIG. 2A is a structural block diagram of a first collecting module of an infrared emitting device according to the present invention.

FIG. 2B is a structural block diagram of a modified structure of a first collecting module of an infrared emitting device according to the present invention.

FIG. 3 is a structural block diagram of a preprocessing module of an infrared emitting device according to the present invention.

FIG. 4 is a structural block diagram of a voice recognition module of an infrared transmitting device according to the present invention.

FIG. 5 is a structural block diagram of an infrared emitter of an infrared emitting device according to the present invention.

FIG. 6A is a structural block diagram of an infrared transmitting device module according to a second embodiment of the present invention.

FIG. 6B is a structural block diagram of a voice binding module of an infrared transmitting device module according to a second embodiment of the present invention.

FIG. 7 is a block diagram showing a module structure of an infrared transmitting device according to a third embodiment of the present invention.

FIG. 8 is a block diagram showing a module structure of an infrared transmitting device according to a fourth embodiment of the present invention.

### DESCRIPTION OF REFERENCE NUMERALS

10. Infrared emitting device; 11, first collecting module; 111, voice collecting unit; 112, output interface unit; 113, signal transmission unit; 114, power supply unit; 115, switch unit; 131, interference suppression unit; 132, noise filtering unit; 14, voice recognition module; 141, threshold setting unit; 142, feature extraction unit; 143, matching analysis unit; 15, infrared transmitter; 151, identification feedback unit; 153, infrared generating unit; 155, infrared emitting unit; 16, storage module; 27, voice binding module; 271, voice binding unit; 272, binding prompting unit ; 28, self-set voice collection module; Two acquisition modules; 321, Level preset unit; 322, a noise collection unit; 323, a noise analysis unit; 333, an adjustment unit; 435, a signal compensation unit.

### DETAILED DESCRIPTION OF THE EMBODIMENTS

Below, embodiments of the present invention will be described in greater detail with reference to the drawings.

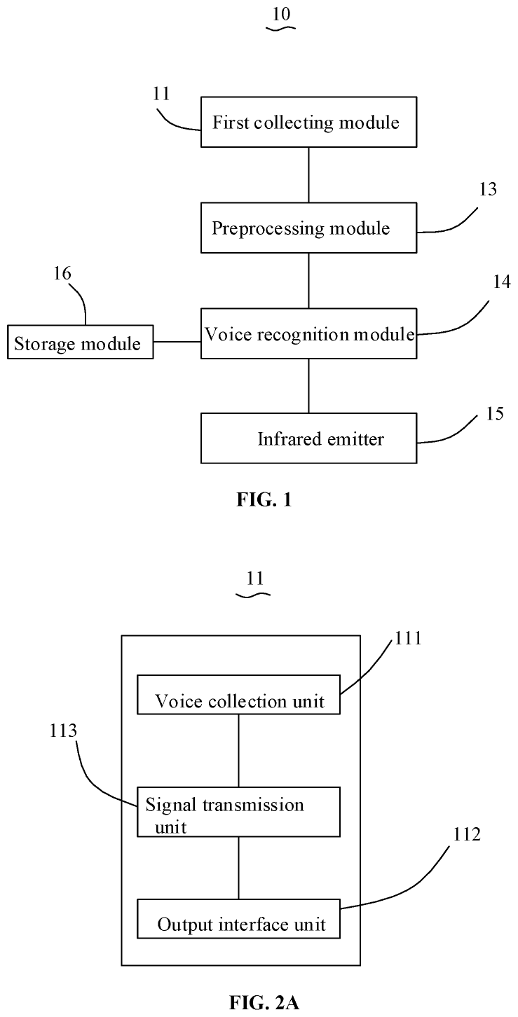

As shown in FIG. 1, an infrared emitting device in accordance with an embodiment, comprises a first collecting module 11, a preprocessing module 13, a voice recognition module 14, an infrared emitter 15, and a storage module 16. The storage module 16 is configured to store one or more preset voice commands, the preset voice commands include one or more preset voice features. The first collecting module 11 is configured to collect the voice data of the user, the preprocessing module 13 is configured to preprocess the voice data collected by the first collecting module 11 to eliminate the interference voice and obtain the target voice. The voice recognition module 14 is connected to the first collecting module 11 and the storage module 16, the voice recognition module 14 is configured to perform feature extraction on the target voice obtained by the preprocessing, and compare the obtained target voice feature with the preset voice feature, and issue corresponding feedback signal according to the comparison result to achieve recognition of the target voice. The infrared emitter 15 is connected to the voice recognition module 14 and generates a corresponding infrared signal according to the feedback signal, thus the voice command can be used to control the electronic device with an infrared sensor in a set range. The electronic device may include, but not to be limited to a refrigerator, an air conditioner, a fan, a television. The setting range depends on a detecting range of the infrared sensor and the transmitting range of the infrared signal. The infrared sensor can extract the infrared signal with a carrier wave having a frequency in a range of 30 kHz-60 kHz. For example, the frequency of the carrier wave may be but not limited to be 38 kHz.

In some embodiments, the infrared emitting device comprises a body. The first collecting module 11, the voice recognition module 14 and the infrared emitter 15 are located in the body.

In other embodiments, the infrared emitting device further comprises an transmitting module, the infrared emitting device comprising a first body, and a second body detachably coupled to the first body. The first collecting module 11 is located in the first body. The voice recognition module 14 and the infrared emitter 15 are located in the second body, the first collecting module 11 is communicated with the voice recognition module 14 via the transmitting module. The transmitting module comprises a transmitting line, the transmitting line is crimped in the first body or the second body, when the first body is detached from the second body, the transmitting line is expanded. The transmitting module comprises a first communicating unit, and a second communicating unit wirelessly communicated with the first communicating unit; the first communicating unit is located in the first body, second communicating unit is located in the second body, the first interface and the second interface are wirelessly communicated detachably couple together. A radio frequency used by the first interface and the second interface is 2.4G, 5.8 GHz, 433 MHz, or in a range of 902-928 MHz.

The infrared emitting device in the following embodiments, comprising a first body and a second body.

The connection referred to in this embodiment refers to a somewhat connected relationship and/or a signal connection relationship between the two, thus signal transmission can be performed between two mutually connected elements.

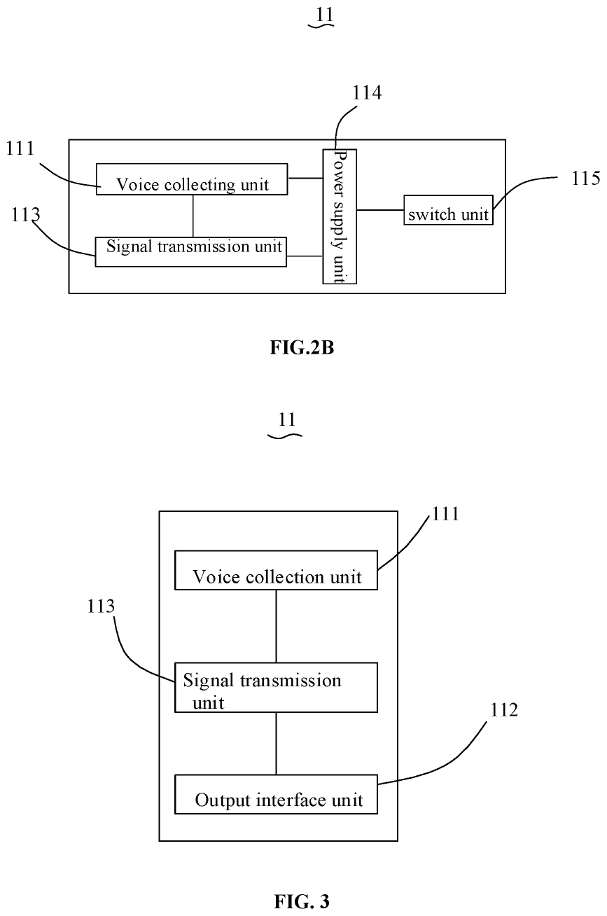

Referring to FIG. 2A, the first collecting module 11 includes a voice collection unit 111 and a signal transmission unit 113. The voice collection unit 111 is configured to acquire the voice data of the user, and the voice collection unit 111 may be a single or multiple, preferably, the voice collection unit 111 is multiple and distributed in an array, wherein the array is distributed in a circular array, or a rectangular array, or polygon array.

The signal transmission unit 113 is connected to the voice collection unit 111 for transmitting the acquired user voice data to the preprocessing module 13 to pre-process the voice data, thereby effectively eliminating the interference voice and obtaining the target voice.

In some embodiments, the first collecting module 11 further includes a signal output interface unit 112. The output interface unit 112 is point-connected to the signal transmission unit 113 and detachably connected to the preprocessing module 13. Therefore, the first collecting module 11 can be detachably connected to each other through the output interface unit 112 and the pre-processing module 13 to facilitate replacement in time when the first collecting module 11 is damaged.

At the same time, the first collecting module 11 and the preprocessing module 13 are detachably connected by wires through the signal output interface unit 112, thus the signal transmission between the first collecting module 11 and the preprocessing module 13 is more stable, thereby ensuring that the preprocessing module has better signal processing effects.

In this embodiment, the signal transmission between the signal transmission unit 113 and the preprocessing module 13 may be transmitted through a wired connection, or may be implemented in a wireless way based on a 3G, 4G network, or WiFi, and is not limited herein.

Referring to FIG. 2B, in some embodiments, the first collecting module 11 further includes a power supply unit 114 and a switch unit 115 , wherein the power supply unit 114 is connected to the voice collection unit 111 and the signal transmission unit 113 to suppy power. The switch unit 115 is connected to the power supply unit 114 for controlling the opening and closing of the power supply unit 114. The switch unit 115 can be a mechanical switch such as a button or a paddle, or an inductive switch such as a touch or a voice control.

Referring to FIG. 3, the preprocessing module 13 includes an interference suppression unit 131 and a noise filtering unit 132. The interference suppression unit 131 is connected to the first collecting module 11 for improving the voice data signal collected by the first collecting module 11 and suppressing the interference signal of the voice data signal during the transmission process, namely, the signal-to-noise ratio of the collected voice data is improved, and high-signal-to-noise ratio voice data is obtained, thus the noise filtering unit 132 can filter the target voice better. The noise filtering unit 132 is connected to the interference suppression unit 131 for filtering the voice data signal processed by the interference suppression unit 131, Namely, high signal noise ratio voice data is processed to filter environmental noise and/or delete blank voice to obtain human voice data, namely target voice, also known as target voice data or target signal.

Referring to FIG. 4, the voice recognition module 14 includes a threshold setting unit 141, a feature extraction unit 142, and a matching analysis unit 143. The feature extraction unit 142 is configured to extract the target voice feature acquired by the preprocessing module 13, and the voice feature may be any one of a sound intensity feature, a loudness feature, a pitch feature, a pitch cycle feature, a combination of the two, or a combination of the three. The sound intensity characteristic, namely the average sound energy per unit area passing through the direction perpendicular to the sound wave propagation direction per unit time; the loudness characteristic of the sound is the degree of sound intensity that we subjectively sense; the pitch characteristic, that is, the feeling of frequency of the human auditory system for sound; the pitch cycle is the time each time the vocal cord is turned on and off. For example, the voice recognition used by the voice recognition module 14 may be a voice recognition algorithm based on a convolutional neural network algorithm and/or voice recognition based on a voiceprint feature extraction.

The threshold setting unit 141 is configured to set a voice feature matching threshold.

The matching analysis unit 143 is configured to compare the target voice feature acquired from the feature extraction unit 142 with the preset voice feature in the storage module 16, and send a feedback signal to the infrared emitter 15 according to the comparison result, and the infrared emitter 15 receives and parses the feedback signal to generate an infrared signal and transmits the infrared signal to the electronic device to control the electronic device.

Specifically, If the ratio between the target voice feature obtained from feature extraction unit 142 and the preset voice feature in storage module 16 is greater than or equal to the voice feature matching threshold set in threshold setting unit 141, the matching analysis unit 143 will send a positive feedback signal to the infrared transmitter 15, and the positive feedback signal includes specific information of the infrared signal to be transmitted, namely the code corresponding to the infrared signal, thus different infrared signals can be sent through different voice commands to control different electrical appliances or different functions of the same appliance. The infrared emitter 15 receives and parses the feedback signal to generate an infrared signal and transmits the infrared signal to the electronic device to control the electronic device. If the ratio between the target voice feature obtained from feature extraction unit 142 and the preset voice feature in storage module 16 is smaller than the voice feature matching threshold set in the threshold setting unit 141, the matching analysis unit 143 sends an infrared conversion negative feedback signal to the infrared emitter 15 or does not send a feedback signal to the infrared emitter 15, that is, the infrared emitter 15 does not emit an infrared signal.

For example, it is assumed that the preset voice feature in the storage module 16 is a related voice feature of the instruction statement “Please turn on the fan” of the user A. If the first collecting module 11 collected relevant voice data of an instruction statement such as “open fan”, “please open fan” or “open fan” in user A or user B, the preprocessing module 13 performs the impurity preprocessing on the voice data of the command statement of the user A or the user B to obtain the target voice data of the command statement, and the feature extraction unit 142 performs voice feature extraction on the target sentence data, the matching analysis unit 143 will obtain an instruction statement such as “open fan”, “please open fan” or “open fan” of A or user B acquired from the feature extraction unit 142, the related target voice feature is compared with the command statement of the user A in the storage module 16 “please open the fan” preset voice feature, if the ratio of the comparison is greater than or equal to the voice feature matching threshold set in the threshold setting unit 141, such as the threshold is 90%, that is, the relevant target voice feature of the command statement such as “open fan”, “please open fan” or “open fan” acquired by the feature extraction unit 142 of the user A or the user B, athe relevant target voice feature compared whit the command statement of the user A in the storage module 16 “please open the fan”, when the ratio of the preset voice features is greater than or equal to 90%, the match is considered successful; the matching analysis unit 143 sends an infrared conversion positive feedback signal to the infrared emitter 15 to generate a corresponding infrared signal, and controls the fan to be turned on by the infrared signal. Conversely, the matching analysis unit 143 sends an infrared conversion negative feedback signal to the infrared emitter 15 or does not emit an infrared conversion feedback signal to the infrared emitter 15, namely the infrared emitter 15 does not operate.

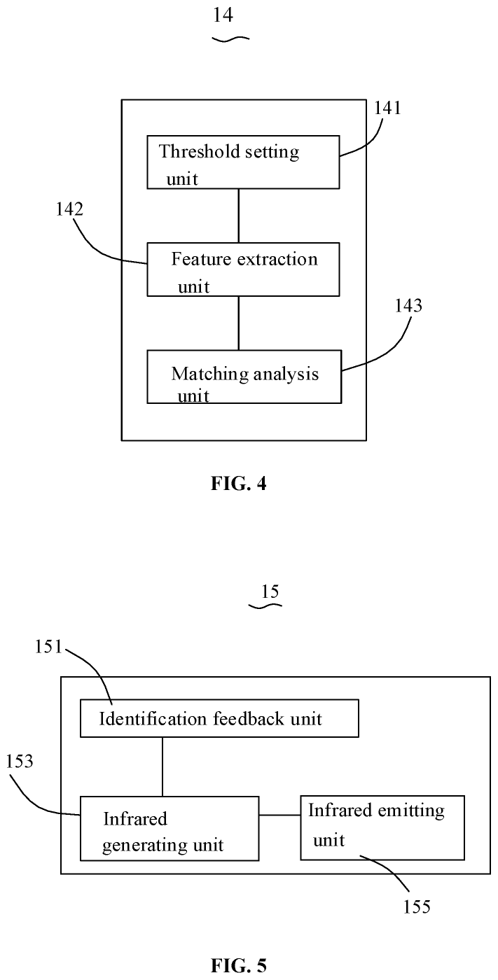

Referring to FIG. 5, the infrared emitter 15 includes an identification feedback unit 151, an infrared generating unit 153, and an infrared emitting unit 155. The identification feedback unit 151 is connected to the infrared generating unit 153 and the matching analysis unit 143 of the voice recognition module 14 for receiving and parsing the feedback signal sent by the matching analysis unit 143, and controlling the infrared generating unit 153 to generate an infrared signal according to the feedback signal, and then the infrared emitting unit 155 sends an infrared signal to an electronic device having an infrared receiver (not shown) to control the electronic device. The infrared receiver

An infrared storage unit (not shown) is disposed in the infrared emitter 15, the infrared storage unit stores an infrared code, and the infrared code in the infrared code storage unit can be collected in advance and stored in the infrared storage unit, and the infrared code is associated with a preset voice instruction. When the ratio of the target voice feature to the preset voice feature is greater than or equal to a set threshold, the infrared emitter 15 transmits an infrared signal generated by the infrared code associated with the preset voice feature to the electronic device.

Specifically, it is assumed that the positive feedback signal is binary code such as “0101” and “0100”, wherein “0101” is mapped with the A infrared signal, and the Class A infrared signal controls the fan to “swing head”; “0100” is mapped with B infrared signal, the B infrared signal controls the fan to “open the fan”

When the identification feedback unit 151 receives the positive feedback signal of the matching analysis unit 143, the positive feedback signal is parsed to obtain the binary code “0100”, then the infrared generating unit 153 is controlled to generate the B infrared signal, the B infrared signal is transmitted to the electronic device through the infrared emitting unit 155, and the fan is controlled to perform an “open fan” action to turn on the fan.

When the identification feedback unit 151 receives the negative feedback signal of the matching analysis unit 143 or does not receives the feedback signal of the matching analysis unit 143, the infrared generating unit 153 does not operate.

In this embodiment, the preset voice command pre-stored in the storage module 16 may be one or more voice commands of one user, or may be multiple voice commands of multiple users. The plurality of voice commands can control the electronic device to perform the same action, it only needs the infrared transmitter 15 to converts the plurality of voice commands into the same infrared signal having the same characteristics, and the infrared signal feature can be the wavelength of the infrared signal and/or frequency. Different voice commands can also be used to control the electronic device to perform different actions, and it only needs the infrared transmitter 15 to convert different voice commands into infrared signals having corresponding features.

In the meantime, the voice feature matching threshold set in the threshold setting unit 141 may also be set according to the preference of the user. The value range of the threshold may be any value greater than zero and less than 1, preferably, the threshold value is α, 1>α≥65%, more preferably, 1>α≥90%.

By using the storage module 16 to store the user preset voice command locally in the present invention, it can realize fast call of the preset voice command data without using the cloud to store the voice command. At the same time, the first collecting module 11 is used to acquire the voice data of the user, the interference suppression unit 131 of the preprocessing module 13 suppresses the interference signal of the voice data firstly, improves the signal-to-noise ratio of the voice data, the noise filtering unit 132 is further used to further eliminate the interference signal, so as to effectively retain the user voice in the voice data, namely the target voice; and then extracting the voice feature in the target voice through the voice recognition module 14, and comparing the feature of the acquired target voice feature with the preset voice feature, if the contrast ratio is greater than or equal to the set threshold, a feedback signal is sent to the infrared emitter 15 which emits an infrared control signal in response to the feedback signal to the electronic device.

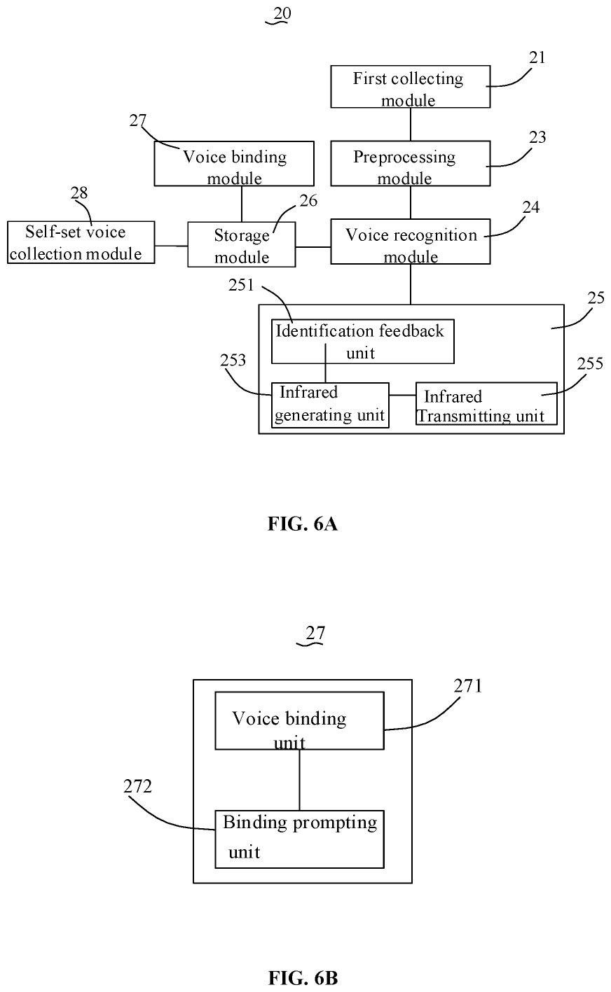

Referring to FIGS. 6A-6B, a second embodiment of the present invention provides an infrared emitting device 20, which includes a first collecting module 21, a preprocessing module 23, a voice recognition module 24, a storage module 26, and an infrared emitter 25.

The first collecting module 21, the preprocessing module 23, the voice recognition module 24, the infrared emitter 25, the storage module 26 have the same connection and function as the first collecting module 11, the preprocessing module 13, the voice recognition module 14, the infrared emitter 15, the storage module 16 corresponding to the first embodiment and are not described herein.

The second embodiment is different from the first embodiment in that the infrared emitting device 20 further includes a self-set voice collection module 28 and a voice binding module 27, wherein the self-set voice collection module 28 is connected to the storage module 26 for collecting the self-set voice command of the user, the self-set voice feature of the self-set voice command is obtained, and the self-set voice feature is stored in the storage module 26, and the voice binding module 27 binds the self-set voice feature to the preset voice feature, so that the user can control the electronic device through the self-set voice.

Specifically, the voice binding module 27 includes a voice binding unit 271 and a binding prompting unit 272, the voice binding unit 271 is connected to the binding prompting unit 272, the self-set voice feature for storing the self-set voice collection module 28 in the storage module 26 is bound to the preset voice feature, and the binding prompt is sent to the binding prompting unit 272 after the binding is successful, and the binding prompting unit 272 receives the binding feedback, and prompts the prompt of the binding success to user. The information may be a flash, a text prompt or a voice prompt, preferably, the prompt information is a voice prompt.

The self-set voice feature collection method of the self-set voice collection module 28 can refer to the collection and processing of the voice command by the first collecting module 21 and the preprocessing module 23, and will not be described again.

For example, the preset voice command “opening fan” corresponds to turning on the fan, when the user wants to turn on the fan with the self-setting voice command “OPEN”, the self-setting voice command “OPEN” is collected by the self-set voice collection module 28, the voice binding unit 271 binds or associates the self-set voice feature of the “OPEN” with the preset voice feature of the preset voice command “opening fan”, and sends a voice prompt “Congratulation, tie” after the binding is successful. Therefore, the user can realize the function of turning on the fan through “OPEN”.

By setting the self-set voice collection module 28 and the voice binding module 27, the user can effectively extend the extension of the preset voice command, so that multiple voice commands can be used to control the same action of the electronic device, thereby effectively reduce the user's inability to operate the electronic device by forgetting a certain voice command.

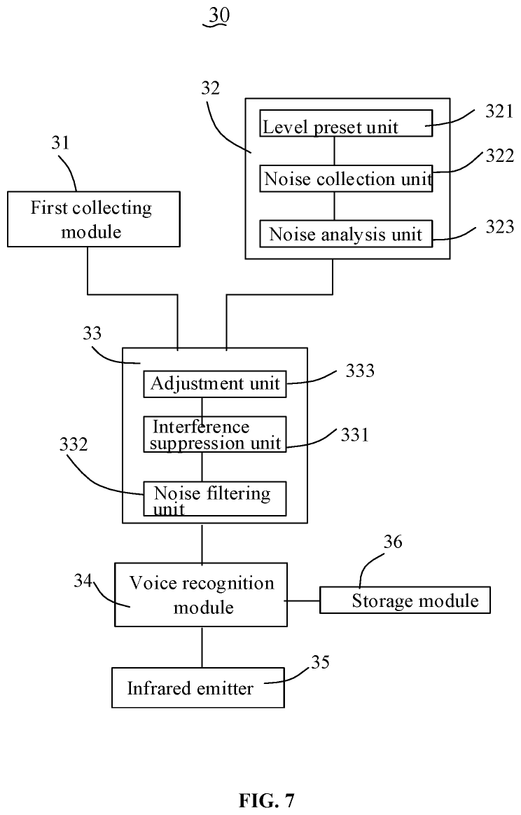

Referring to FIG. 7, a third embodiment of the present invention provides an infrared emitting device 30, the infrared emitting device 30 includes a first collecting module 31, a second collecting module 32, a preprocessing module 33, a voice recognition module 34, an infrared emitter 35 and a storage module 36.

The first collecting module 31, the voice recognition module 34, the storage module 36, and the infrared emitter 35 have the same connection relationship and function with the first collecting module 11, the voice recognition module 14, the storage module 16, and the infrared emitter 15 corresponding to the first embodiment, do not repeat again.

The second collecting module 32 is connected to the preprocessing module 33 for collecting ambient noise and analyzing the noise level of the environmental noise, and feeding back the noise level to the preprocessing module 33, thus the preprocessing module 33 adjusts the noise filtering intensity according to different noise levels.

Specifically, the second collecting module 32 includes a level preset unit 321, a noise collection unit 322, and a noise analysis unit 323. The level preset unit 321 is configured to preset a noise level, the noise collection unit 322 is configured to collect noise of an environment in which the infrared emitting device 30 is located. The noise analysis unit 323 is connected to the level preset unit 321 and the noise collection unit 322, the noise analysis unit 323 compares the ambient noise collected by the noise collection unit 322 with the noise level preset by the level preset unit 321 and determines the noise level collecting by the noise collection unit 322, the feedback signal of the noise level is transmitted to the preprocessing module 33 to cause the pre-processing module 33 to adjust the noise filtering intensity according to different noise levels.

The preprocessing module 33 includes an adjustment unit 333, an interference suppression unit 331, and a noise filtering unit 332. The interference suppression unit 331 and/or the noise filtering unit 332 are provided with a plurality of intensity levels, and the adjustment unit 333 is connected to the noise analysis unit 323, the interference suppression unit 331, and the noise filtering unit 332 for adjusting the interference rejection intensity of the interference suppression unit 331 and/or the noise filtering intensity of the noise filtering unit 332 according to the noise level determined by the noise analysis unit 323, to obtain better target voice and ensure better voice recognition effect.

For example, set the sound of 20-40 decibels to be three-level noise, set the sound of 40-60 decibels to be the second-level noise, set the sound of 60-90 decibels to the third-order noise, and set the sound of more than 90 decibels to be the fourth-level noise. When the ambient noise collected by the noise collecting unit 322 is between 40 and 60 decibels, the noise analyzing unit 323 determines that the noise level is secondary noise, generates a secondary noise feedback signal, transmits the secondary noise feedback signal to the adjustment unit 333, and the adjustment unit 333 adjust the intensity level of the noise analysis unit 323 and/or the interference suppression unit 331.

It can be understood that, in some embodiments, the first collecting module 31, the voice recognition module 34, the storage module 36, and the infrared emitter 35 correspond to the first collecting module 21, the voice recognition module 24, the storage module 26, and the infrared emitter 25 corresponding to the second embodiment, and will not be described here.

The present invention set the second collecting module 32 to acquire the ambient noise and analyzes the noise level of the ambient noise, and feed the noise level to the preprocessing module 33, thus the preprocessing module 33 can adjust the noise filtering intensity according to different noise levels to obtain better target voice and ensure better voice recognition effect.

As a variant of the third embodiment, an infrared emitting device 30 provided by the third embodiment may further include a self-set voice collection module and a voice binding module, and respectively set with the self-setting in the second embodiment. The connection mode and function of the voice collection module 28 and the voice binding module 27 are the same, and are not described herein.

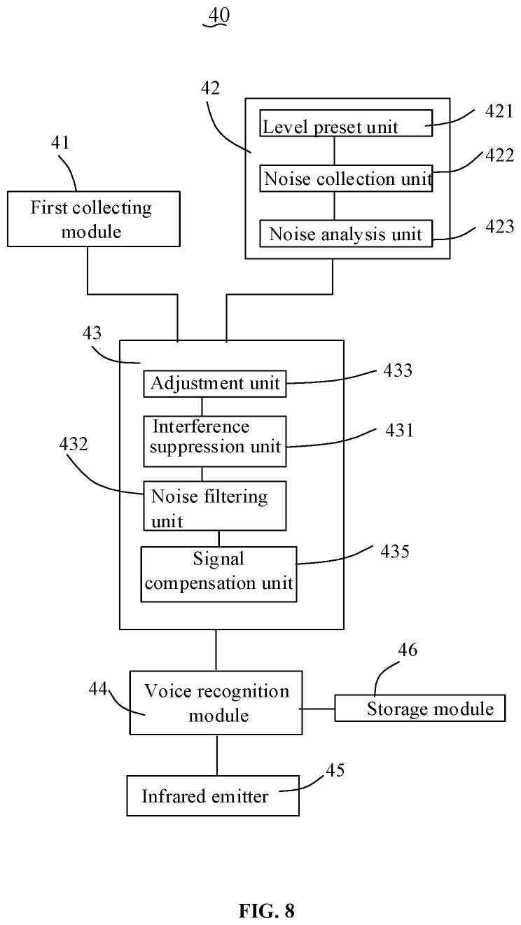

Referring to FIG. 8, a fourth embodiment of the present invention provides an infrared emitting device 40, which includes a first collecting module 41, a second collecting module 42, a preprocessing module 43, a voice recognition module 44, and a storage module 46, and an infrared emitter 45.

The first collecting module 41, the second collecting module 42, the voice recognition module 44, the storage module 46, and the infrared emitter 45 correspond to the first collecting module 31, the second collection module 32, and the voice recognition module 34, the storage module 36 and the infrared emitter 35 corresponding to the third embodiment, have the same connection relationship and function, and are not described herein.

The fourth embodiment is different from the third embodiment in that the preprocessing module 43 includes an adjustment unit 433, an interference suppression unit 431, a noise filtering unit 432, and a signal compensation unit 435. The adjustment unit 433, the interference suppression unit 431, and the noise filtering unit 432 have the same connection relationship and function as the adjustment unit 333, the interference suppression unit 331 and the noise filtering unit 332 corresponding to the third embodiment, and are not described herein.

The signal compensation unit 435 is coupled to the noise filtering unit 432 for compensating for data loss compensation for the voice command data possible parameters during the noise processing by the interference suppression unit 431 and the noise filtering unit 432. The compensation amount can be a fixed value or set by the collected environmental noise level, thus the conversion effect on the voice command is better.

A fifth embodiment of the present invention further provides an electrical control system including an electronic device and an infrared emitting device, the infrared emitting device has the same connection relation and function with any of the infrared emitting device 10 provided by the first embodiment, and the infrared emitting device 20 provided by the second embodiment, the infrared emitting device 30 provided by the third embodiment, and t the infrared emitting device 40 provided by the fourth embodiment, and are not described herein. The electrical control system can convert the user's voice command into a corresponding infrared signal by providing an infrared emitting device, thereby realizing remote control of the electronic device.

Compared with the prior art, an infrared emitting device provided by the present invention has the following advantages:

By using the storage module to store the user preset voice command locally, the voice command data can be quickly called without using the cloud to store the voice command. At the same time, the first collecting module is used to acquire the user's voice data, and the interference suppression unit of the preprocessing module first suppresses the interference signal of the voice data, improves the signal-to-noise ratio of the voice data, and then uses the noise filtering unit to further eliminate the interference signal, effectively retain the user's voice in the voice data, that is, the target voice; then extract the voice feature in the target voice through the voice recognition module, and compare the feature of the acquired target voice feature with the preset voice command, if the contrast ratio is greater than Or equal to the set threshold, a feedback signal is sent to the infrared emitter, and the infrared signal is sent to the electronic device to control the electronic device.

By setting the self-set voice collection module and the voice binding module, the user can effectively expand the extension of the preset voice command, so that multiple voice commands can be used to control the same action of the electronic device, thereby effectively reducing the situation that users cannot operate electrical equipment because of forgetting voice commands.

Setting the second collecting module, the second collecting module be used to obtain the environmental noise and analyze the noise level of the environmental noise, and feedback the noise level to the preprocessing module, so that the preprocessing module adjusts the noise filtration intensity according to different noise levels to obtain better target voice, ensuring better sound recognition.

The above embodiments are merely preferred embodiments of the present invention, and the scope of the present invention is not limited thereto, and any insubstantial changes and substitutions made by those skilled in the art based on the present invention belong to the present invention. The scope of the claim.

What is claimed is:

1. An infrared emitting device, configured to convert a voice command into an infrared signal and transmit the infrared signal to an electronic device for controlling the electronic device, the infrared emitting device comprising:
a first collecting module, configured to collect user's voice data;
a voice recognition module, configured to extract target voice features from target voice and compare the target voice feature with a preset voice feature;
an infrared emitter, configured to emit a corresponding infrared signal to the electronic device for controlling the electronic device, when the target voice feature matches the preset voice feature.

2. The infrared emitting device of claim 1, wherein the infrared emitting device further comprises a transmitting module, the infrared emitting device comprising a first body, and a second body detachably coupled to the first body, the first collecting module is located in the first body, the voice recognition module and the infrared emitter are located in the second body, the first collecting module is communicated with the voice recognition module via the transmitting module.

3. The infrared emitting device of claim 2, wherein the transmitting module comprises a transmitting line, the transmitting line is crimped in the first body or the second body, when the first body is detached from the second body, the transmitting line is expanded.

4. The infrared emitting device of claim 2, wherein the transmitting module comprises a first communicating unit, and a second communicating unit wirelessly communicated with the first communicating unit; the first communicating unit is located in the first body, second communicating unit is located in the second body, the first interface and the second interface are wirelessly communicated detachably couple together.

5. The infrared emitting device of claim 2, wherein the infrared emitting device further comprises a preprocessing module, configured to receive the voice data and pre-process the voice data to obtain the target voice.

6. The infrared emitting device of claim 2, wherein the infrared emitting device further comprises a storage module, configured to store a preset voice command having the preset voice feature.

7. The infrared emitting device of claim 1, the infrared emitting device comprising a body, the first collecting module, voice recognition module and the infrared emitter are located in the body.

8. The infrared emitting device of claim 7, wherein the infrared emitting device further comprises a preprocessing module, configured to receive the voice data and preprocess the voice data to obtain the target voice.

9. The infrared emitting device of claim 7, wherein the infrared emitting device further comprises a storage module, configured to store a preset voice command having the preset voice feature.

10. The infrared emitting device of claim 5, wherein the preprocessing module comprises an interference suppression unit and a noise filtering unit, wherein the interference suppression unit is connected to the first collecting module, and the voice data is processed by the interference suppression unit to obtain a high SNR voice data; the noise filtering unit is connected to the interference suppression unit for processing the high SNR voice data to obtain the target voice.

11. The infrared emitting device of claim 1, wherein an infrared storage unit is disposed in the infrared emitter, the infrared storage unit stores an infrared code, and the infrared code is associated with the preset voice command;
when the ratio of the target voice feature to the preset voice feature is greater than or equal to a set threshold, the infrared emitter transmits an infrared signal generated by the infrared code associated with the preset voice feature to the electronic device.

12. The infrared emitting device of claim 1, wherein the array is distributed in a circular array, a rectangular array or a polygonal array.

13. The infrared emitting device of claim 1, wherein the infrared emitting device further comprises a second collecting module, wherein the second collecting module is connected to the preprocessing module for acquiring an environment noise, the ambient noise level is analyzed, and the ambient noise level information is fed back to the preprocessing module.

14. The infrared emitting device of claim 8, wherein the second collecting module comprises a level preset unit, a noise collection unit, and a noise analysis unit; the level preset unit is configured to preset a noise level, the noise collecting unit is configured to collect ambient noise; the noise analyzing unit is connected to the level preset unit and the noise collecting unit, and is used for comparing the ambient noise collected by the noise collecting unit with the preset noise level of the level preset unit, and determining the noise level collected by the noise collection unit, and transmitting the feedback signal of the noise level to the preprocessing module.

15. The infrared emitting device of claim 4, wherein a radio frequency used by the first interface and the second interface is 2.4G, 5.8 GHz, 433 MHz, or in a range of 902-928 MHz.

16. An electrical control system, comprising:
an electronic device; and
an infrared emitting device, comprising:
a first collecting module, configured to collecting user's voice data of a user;
a voice recognition module, connected to the preprocessing module, configured to extract target voice features from the target voice, and compare the obtained target voice feature with a preset voice feature; and
an infrared emitter configured to emit a corresponding infrared signal to the electronic device for controlling the electronic device, when the target voice feature matches the preset voice feature.
